(19) United States
(12) Patent Application Publication
(10) Pub. No.: US 2015/0159424 A1
(43) Pub. Date: Jun. 11, 2015

(54) PIVOT REINFORCEMENT DEVICE

(71) Applicant: GREGORY ABORHEY, MONTGOMERY VILLAGE, MD (US)

(72) Inventor: GREGORY ABORHEY, MONTGOMERY VILLAGE, MD (US)

(21) Appl. No.: 14/480,547

(22) Filed: Sep. 8, 2014

Related U.S. Application Data
(60) Provisional application No. 61/874,481, filed on Sep. 6, 2013.

(51) Int. Cl. E06B 3/88; E05D 15/26

(52) U.S. Cl. CPC E06B 3/88; E05D 15/264

(57) ABSTRACT

A bi-fold door pivot reinforcement for a folding door system that includes: a mounting brace; at least two screws, wherein the at least two screws insert into the mounting brace for placement of the pivot reinforcement onto a folding door; and a reinforcement edge extending from the mounting brace at about a 90-degree angle. The pivot reinforcement according to the present invention may be mounted above a bottom edge of a folding door.

### CROSS REFERENCE TO OTHER APPLICATIONS

This application claims priority to U.S. Provisional Application Ser. No. 61/874,481 filed on Sep. 6, 2013.

### BACKGROUND OF THE INVENTION

1. Field of Invention

The present invention relates to a pivot reinforcement that is used in conjunction with a bi-folding door.

2. Description of Related Art

A folding door is used in certain openings to provide easy and convenient access to a room or closet. The folding door opens in sections and is usually on a track that supports the door within the doorframe. The folding door provides a division between rooms and may occasionally be used in storage and closet areas. Many times these doors may become damaged and need to be repaired or new bi-fold doors need to be installed. One way to avoid new door installation is to create a system or a device that may be attached to bi-fold doors that are damaged to provide a reinforcement of the door in order to avoid complete replacement of the door.

### SUMMARY OF THE INVENTION

The present invention relates to a bi-fold door pivot reinforcement for a folding door system comprising: a mounting brace; at least two screws, wherein the at least two screws insert into the mounting brace for placement of the pivot reinforcement onto a folding door; and a reinforcement edge extending from the mounting brace at about a 90-degree angle. The bi-fold door pivot reinforcement according to claim 1, wherein the pivot reinforcement is mounted on above a bottom edge of a folding door.

### BRIEF DESCRIPTION OF DRAWINGS

FIG. 1 depicts placement of a pivot reinforcement brace onto a section of a folding door.

### DETAILED DESCRIPTION

The present invention relates to a pivot reinforcement device that is used to reinforce a damaged folding door. The pivot reinforcement device includes a mounting brace and at least two screws that insert into the mounting brace. The mounting brace is placed onto the surface of the folding door in order to mount the reinforcement onto the folding door. A reinforcement edge extends at a 90 degree angle from the mounting brace and provides a means to support and reinforce the damaged folding door.

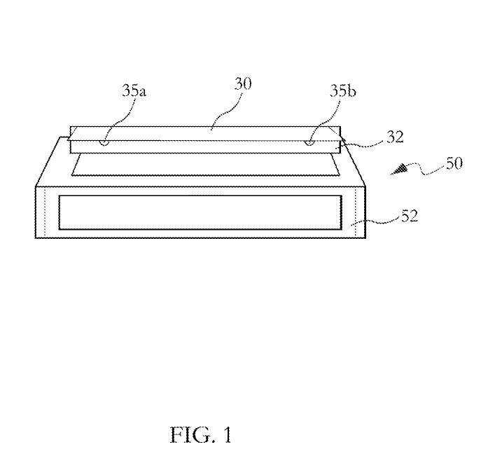

In reference to FIG. 1, a pivot reinforcement device in accordance with the present invention is depicted. The pivot reinforcement includes a reinforcement edge 30 that extends at a 90-degree angle from the mounting brace 32. In this particular embodiment, two screws 35a, 35b are used to mount the reinforcement device onto a folding door 50. The folding door 50 includes a bottom edge 52 and the reinforcement is provided just above the bottom edge 52 of the door 50. Placement of the pivot reinforcement in accordance with the present invention helps to avoid the replacement of installation of folding doors. This reinforces the pivots on the existing folding door and one particular embodiment may include the use of a wood block that adds additional durability for the reinforcement device. The pivot reinforcement eliminates any gap between the floor and doorframe and therefore allows for a smooth moving and stable folding door. The pivot reinforcement may be manufactured in various lengths. Some exemplary lengths include 12, 15 or 18 inches for placement onto the folding door sections. The instant invention has been shown and described in what it considers to be the most practical and preferred embodiments. It is recognized, however, that departures may be made there from within the scope of the invention and that obvious modifications will occur to a person skilled in the art.

What is claimed is:

1. A bi-fold door pivot reinforcement for a folding door system comprising:
a mounting brace;
at least two screws, wherein the at least two screws insert into the mounting brace for placement of the pivot reinforcement onto a folding door; and
a reinforcement edge extending from the mounting brace at about a 90-degree angle.

2. The bi-fold door pivot reinforcement according to claim 1, wherein the pivot reinforcement is mounted above a bottom edge of a folding door.

3. The bi-fold door pivot reinforcement according to claim 1, wherein the mounting brace varies length.

4. The bi-fold door pivot reinforcement according to claim 3, wherein the length may be at least one of 12 in., 15 in. and 18 in. in length.
